(19) United States
(12) Patent Application Publication
(10) Pub. No.: US 2003/0140344 A1
(43) Pub. Date: Jul. 24, 2003

(54) Wireless control for universal plug and play networks and devices

(76) Inventor: Ghulam Bhatti, Union, NJ (US)

Correspondence Address: Patent Department, Mitsubishi Electric Research Laboratories, Inc., 201 Broadway, Cambridge, MA, 02139, US

(21) Appl. No.: 10/054,011

(22) Filed: Jan. 21, 2002

(51) Int. Cl. H04N 7/16

(52) U.S. Cl. 725/62

(57) ABSTRACT

A method and apparatus provides a control point for a Universal Plug and Play network (UpnP) that provides a UPnP stack implementation partitioned between two components of the control point. The control point includes a base set with a first part of the partitioned UPnP stack and a wireless control set with the second part of the stack. The base set is connected to the wired network. The wireless control set communicates with the base set over a wireless link using wireless technology. The wireless control set can send and receive wireless command and status communications to and from the base set. The base set has the required software, firmware, and hardware that allows it to establish and use a wireless connection for communication with the control set.

### FIELD OF THE INVENTION

The invention relates generally to networked devices, and more particularly to controlling networked universal plug and play devices.

### BACKGROUND OF THE INVENTION

“Plug and Play” (PnP) is a technology for automatically configuring personal computer system hardware, software, and attached peripheral devices. A user can attach, i.e., plug in, a new device, such as modem, fax card or game device, into the system and start using the device, i.e., start playing, without having to configure the system, software, and device manually.

Plug and Play technology is implemented in hardware, operating systems such as Microsoft® Windows® 2000, supporting software such as drivers, BIOS, and application software. It should be noted that Plug and Play is a combination of system BIOS, hardware devices, system resources, device drivers, and operating system software. With Plug and Play, the operating system and the BIOS can communicate with each other to share information about system resources.

Plug and Play should not be confused with Universal Plug and Play (UPnP). Emerging technologies for home networking such as UPnP, Jini and UPnP solutions aim at connecting consumer electronic devices and electrical appliances via a local network in order to provide an effective and user friendly control mechanism for those devices without necessarily using a PC. UPnP is a coordination framework that provides a means of device interaction in the UPnP network with the ultimate aim of simple, seamless and scaleable device inter-operability.

A prior art UPnP network includes UPnP devices, one or more UPnP control points (UPnP CP), and optionally, bridges. The user can control the operations of the UPnP devices by sending commands via the UPnP CP. Bridges are used to provide an interface to non-UPnP devices and other networks. Currently, the personal computers are used as the UPnP CP because of their networking capability, processing power, and availability of graphical user interface (GUI). Other devices with a large display, such as a high definition televisions (HDTV), are also considered good candidate to act as a UPnP CP. UPnP devices and the UPnP CP are usually connected to a wired network using any suitable physical communications layer, e.g., 10/100BaseT, Fire Wire IEEE1394, etc.

UPnP provides networking capabilities by using pre-existing network protocols and standards such as Internet protocol (IP), hyper text transportation protocol (HTTP), simple device discovery protocol (SDDP), simple object access protocol (SOAP), general event notification architecture (GENA), and extensible markup language (XML).

The UPnP standard specifies the control point (CP) which is used for controlling the operations of devices connected in the UPnP network. Communications between the devices and the UPnP CP take place by exchanging XML formatted messages. The user, however, does not need to be aware of the format and semantics of the messages because the UPnP network works seamlessly. The UPnP CP usually includes a user-friendly graphical user interface (GUI), normally with graphical buttons for easy access to the control functions of the devices.

Typically, a stack for a UpnP implementation includes six layers: addressing, discovery, description, control, eventing and presentation.

Addressing

Addressing enables communication between networked devices using dynamic host configuration protocol (DHCP). In UPnP, a DHCP server assigns temporary IP addresses to hosts. This is known as dynamic allocation. Dynamic allocation allows sharing of a limited number of IP addresses among many hosts.

Discovery

Discovery allows devices added to the UpnP network to “advertise” their presence to the control point. Discovery also allows control points to search for and discover devices. By utilizing a simple device discovery protocol (SDDP) and general event notification architecture (GENA), the control point can be made aware of available resources on the network and can update that information as needed.

Description

Description enables the control point to “learn” how to access a device discovered on the UpnP network and to obtain a device description that indicates the services and functions offered by the device. The control point can retrieve the device and service information by sending an HTTP request using a Universal Resource Locator (URL) of the device obtained during discovery.

Control

The UPnP control point can control devices by sending HTTP requests to the devices using their URLs. The devices can notify the control point of a result by returning an HTTP response. The requests and responses are encapsulated using SOAP, and transmitted over the UPNP network.

Eventing

The UPnP control point can monitor the states of services provided by the UpnP devices. Using the GENA protocol, the control point can request notification of any change in states of the services. The control point sends the HTTP request to the device to subscribe to receive notification. The device sends an event message in response. Thereafter, the device sends notifications to the control point of any change in states of the services.

Presentation

Presentation enables the control point to provide the user with an interface for controlling the devices on the network, as well as presenting status information for those devices. Typically, the graphical user interface provides the interface for the presentation.

Prior art UPnP CPs possess the required processing power, graphical interface software, such as browsers, and the networking capability to act as control points of the UPnP network. However, those devices are generally costly, unsuitable to a common non-technical person, and non-portable. Further, those devices require a substantial amount of power to operate. More important, those devices need to be directly connected to the wired network that connects the UPnP devices.

Several methods for accessing networked devices are known, for example, “Proxy-bridge connecting remote users to a limited connectivity network,” Publication No. US 200/0033554, published on Oct. 25, 2001. That method basically extends access to devices in a piconet by an external device residing outside the piconet.

“Architecture of a bridge between a non-IP network and the web,” Publication No. US 2001/0032273, published on Oct. 18, 2001, describes a bridge that can be used to facilitate communications between the devices in IP-compatible networks and non-IP-compatible networks.

“Internet Protocol interface for controlling non-IP-based network device with IP-based network device and method therefore,” Publication No. US 2001/0025322 was published on Sep. 27, 2001. That application described a method and mechanism for controlling network devices in a non-IP-based network by a device in an IP-based network.

The above references are related to facilitating access from one network domain to another network. However, control points in those networks are not portable, and cannot be handheld. Also, those devices require a physical connection with a wired UPnP network for communications. Moreover, those devices are unsuitable for battery-powered operation because of their significant power consumption.

The traditional UPnP CP, e.g., a HDTV or PC, needs a significant amount of processing power and a substantial amount of software in order to be able to: (i) send, receive, and process XML based UPnP messages using the TCP/IP protocol, and (ii) provide GUI based interface for the user for an efficient and user friendly control over the networked devices. The prior art UPnP CP needs additional hardware and an extra layer of a related software stack for establishing and using a wireless link. The need for more processing power, along with the constraints on battery capacity, poses a significant challenge for system designer.

“Implementing UPnP on a Mobile Station,” T. Gajdos and M. Kretz, Lund Institute of Technology, 2000, described a portable UPnP control point implemented on a cellular telephone. As a limitation, the constraints of memory and network usage of the cellular telephone reduces the functionality of that UPnP control point.

FIG. 1 shows the layers of a standard UPnP stack 100 used by a prior art UPnP control point.

UPnP device architecture 130 provides a template for creating device and service descriptions of any type. The UPnP forum working committee protocols 120 standardize each device type and service type in order to create a template for each individual device or service type. A vendor defined protocol 110 allows a vendor to supply device or service specific information for each device, i.e., model number, name, URL for a service description, etc. The device specific UPnP information is then inserted into all messages before they are formatted 140 using SSDP, SOAP and GENA and delivered via HTTP, HTTP multicast over UDP (HTTPMU) or HTTP unicast over UDP (HTTPU).

User datagram protocol (UDP) 150, is a connectionless protocol that, like transmission control protocol (TCP) 150, runs on top of the IP layer 160 of networks. Unlike TCP, UDP provides limited error recovery services, offering instead a direct way to send and receive datagrams over the IP network. UDP is used primarily for broadcasting messages over the network.

When the UPnP control point is wireless, the prior art only teaches implementing the entire UPnP protocol stack on a device such as a mobile phone, e.g., “Implementing UPnP on a Mobile Station,” T. Gajdos and M. Kretz, Lund Institute of Technology, 2000, see above. This increases the complexity and power consumption of the control point.

FIG. 2 shows a prior art wireless control point protocol stack 200 for a UPnP control point as described by Gajdos et al. Subject to the limitations of available memory and storage, that wireless device itself includes the entire UPnP protocol stack 100. The wireless device also includes a wireless stack 230, e.g., Bluetooth, and a point-to-point protocol 220 (PPP) to communicate with a UPnP network 250 over a wireless link 235 through a wireless access point 240, e.g., Bluetooth access point (BAP). As a characteristic, prior art wireless devices, such as a mobile telephone, do not provide an adequate user interface for interaction with devices on a UPnP network.

Therefore, there is a need for a UPnP control point that partitions system functions among components in an optimal way to provide fully implemented wireless UPnP control to a user using a minimal amount of resources, and that can be handheld.

### SUMMARY OF THE INVENTION

The invention provides a control point for a Universal Plug and Play network (UpnP) that provides a UPnP stack implementation partitioned between two components of the control point.

The control point includes a base set with a first part of the partitioned UPnP stack and a wireless control set with the second part of the stack. The base set is connected to the wired network. The wireless control set communicates with the base set over a wireless link using wireless technology.

The wireless control set can send and receive wireless command and status communications to and from the base set. The control set is equipped a graphical user interface so that a user may easily enter commands for devices on the UPnP network and read communications received from the network and devices via the base set. All of the protocols required for all steps of the UPnP networking process may be partitioned between the base set and the wireless control set according to desired operating parameters, e.g., processing speed, battery life. In a preferred embodiment, the wireless control set can be implemented with only the presentation step protocol while the base set implements the protocols for the remaining steps.

The base set has the required software, firmware, and hardware that allows it to establish and use a wireless connection for communication with the control set. Further, the base set has sufficient memory to service a large scale network with many devices. Power for the base set is provided by a limitless power supply, e.g., an AC power supply. The control set uses a battery power supply.

### BRIEF DESCRIPTION OF THE DRAWINGS

FIG. 1 is a block diagram of the layers of a prior art UPnP protocol stack;

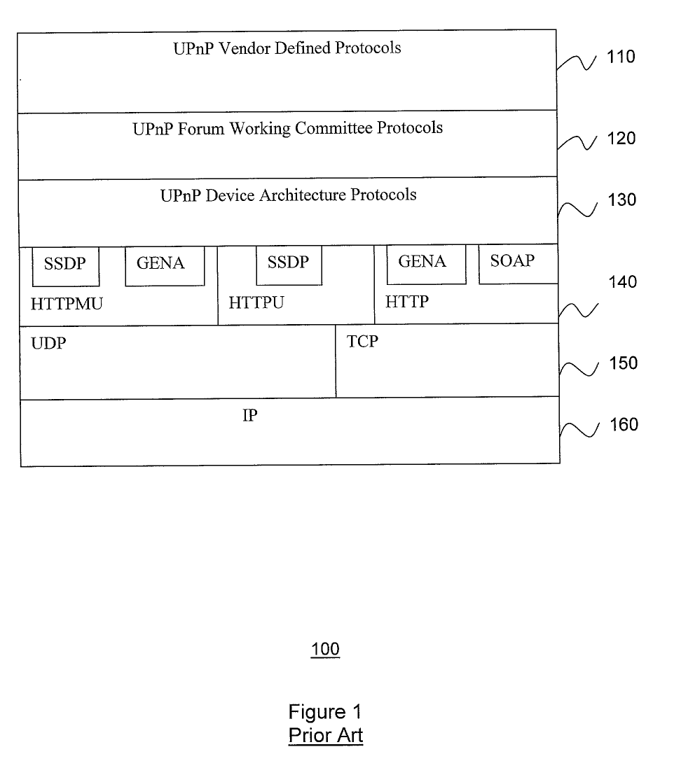

FIG. 2 is a block diagram of the layers a prior art wireless control point including the UPnP stack of FIG. 1;

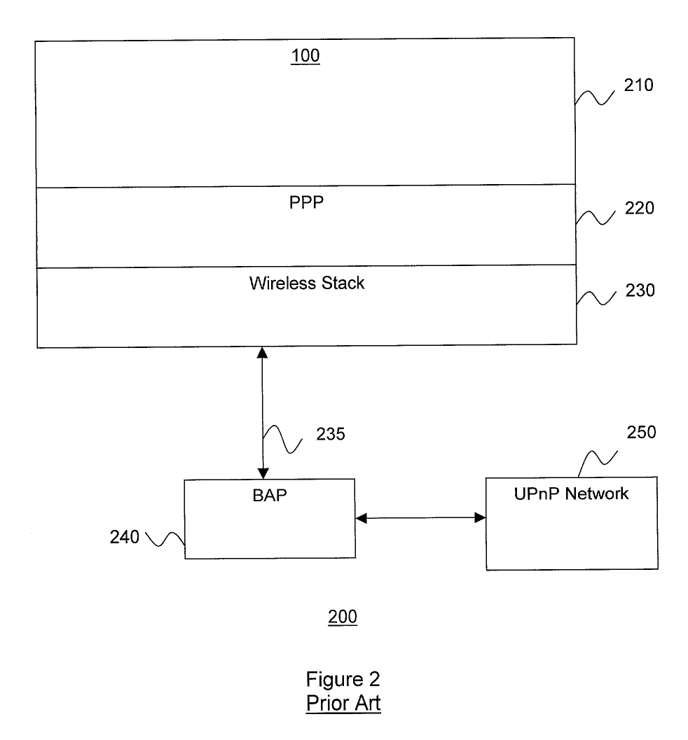

FIG. 3 is a block diagram of a partitioned protocol stack for a UPnP control point according to the invention; and

FIG. 4 is a block diagram of a UPnP system according to the invention.

### DETAILED DESCRIPTION OF THE PREFERRED EMBODIMENT

Partitioned UPnP Stack

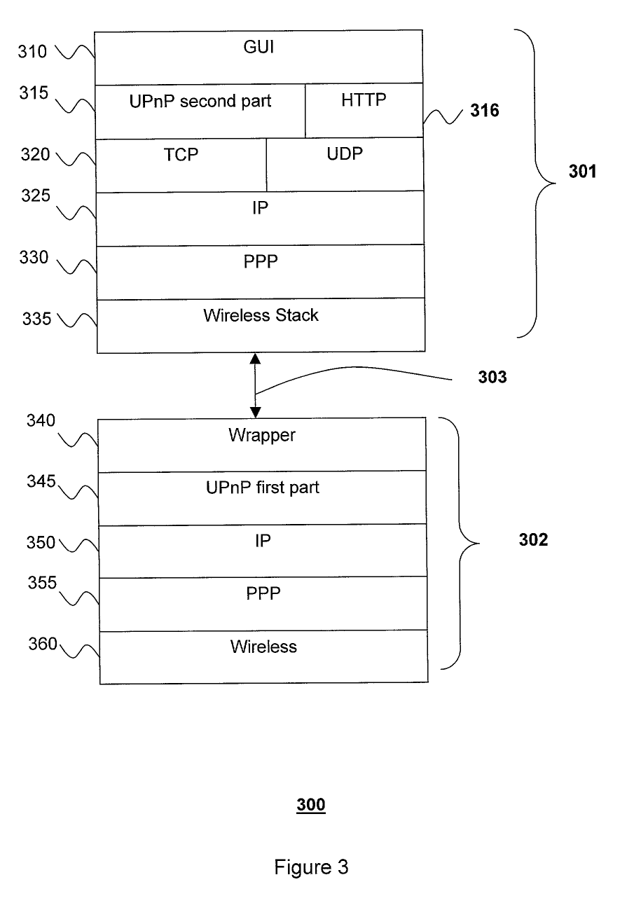

FIG. 3 shows some of the components 300 of a preferred embodiment of a Universal Plug and Play (UPnP) control point according to the invention. As a feature, the control point includes a partitioned UPnP stack, described in further detail below.

The control point 300 includes a control set stack 301 and a base set stack 302 preferably connected by a wireless communications link 303.

Control Set

The control set stack 301 includes hardware and software that implements a graphical user interface 310 on top of a second part of the partitioned UpnP stack 315 and an HTTP layer 316 sufficient to implement at least the presentation step of the UpnP protocol stack.

These protocol layers execute on top of TCP/UDP layers 320, a control set IP layer 325, a control set PPP layer 330 and a control set wireless stack 335, which enable communication via a UPnP the network and across the wireless link 303.

Base Set

The base set stack 302 includes a wrapper application layer 340 for data transmission over the wireless link 303, a first part of the standard UPnP stack 345, a base set IP layer 350, a base set PPP layer 355 and a base set wireless stack 360, which enable communication over the network and across the wireless link.

System Structure

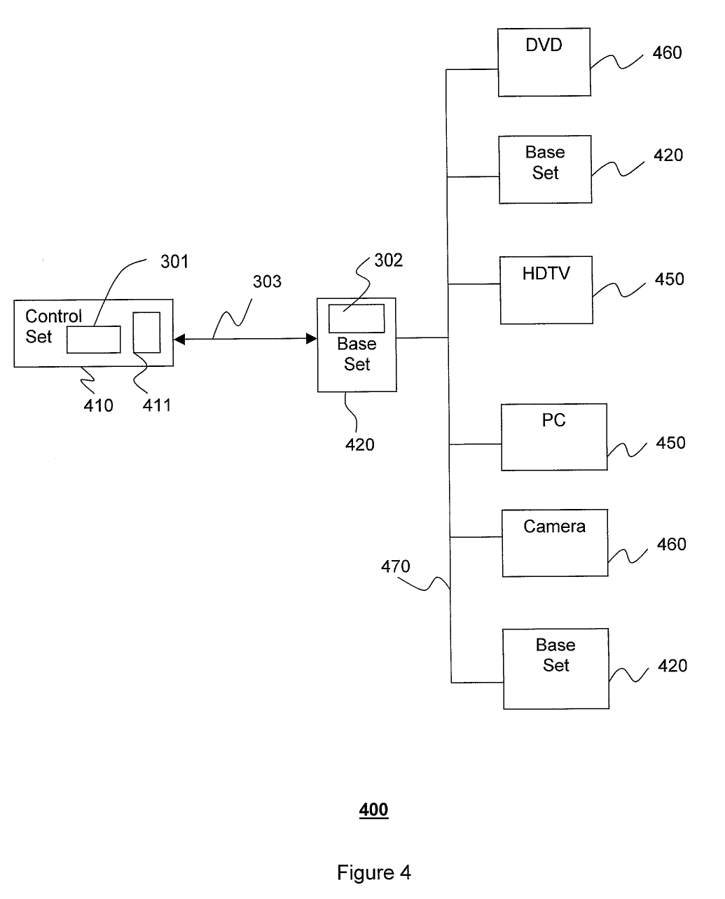

FIG. 4 shows a UPnP system 400 according to a preferred embodiment of the invention. The system 400 includes a wireless control set 410 and a wired base set 420, preferably connected to each other the wireless communications link 303. The control set 410 includes a graphical users interface (GUI) 411 and the control set stack 301 including the second part of the UPnP stack 315, as described above. The base set 420 includes the base set stack 302 including the first part of the UpnP stack 345. The system also includes UPnP devices 450 and 460 connected by a network 470 to the base set 420. The devices 450 and 460 on the network 400 can include devices with UPnP CP implementation 450 and devices without UPnP CP implementation 460.

Optionally, there can be multiple base sets 420. In this case, the control set 410 communicates with the base set over a link with a highest signal strength.

System Operation

During operation of the invention, the base set 420 performs the steps and functions of addressing, discovery, description, eventing and control of the UpnP devices. The wireless control set 410 performs the steps and functions of the presentation layer.

When the control point 430 has discovered one of the UPnP devices 450 or 460 on the network 470 and has received a description of the device, the wireless control set GUI 411 can display a presentation page retrieved from the device, or the control set can simply display an icon representing the presence of the device.

The user can enter UPnP commands into the wireless control set. The commands can cause to the UPnP devices to perform their various operations. The commands can also determine device status or change status. The control set composes an UPnP message for the command and wraps the message in a special wrapper to transmit the command to the base set over the wireless link 303. The wireless technologies that can be used for this purpose include Bluetooth, Home RF, IEEE802.11a, and IEEE802.11b. The base set 420 receives the command transmitted by the control set, unwraps the command and forwards the message to the target device via the network 470.

In response to the received message, the target device can generate a UPnP status message. The base set wraps the status message, and transmits the status message to the control set 410 over the wireless link. The control set receives and unwraps the UPnP status message, and presents the message to the user with the control set GUI 411.

The control set can automatically display a list or menu of graphical icons, one for each UPnP device currently active, i.e., powered on, and connected to the wired network. In addition, when a new UPnP device is connected to, or disconnected from, the wired network 470, the control set can update the list of icons for connected UPnP devices to include, or remove, the icon for the newly connected or disconnected device.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. An apparatus for controlling devices connected to a wired network comprising:
a base set, connected to the wired network, including a first part of a UPnP stack; and
a control set, connected to the base set by a communications link, including a second part of the UPnP stack and a graphical user interface.

2. The apparatus of claim 1 wherein the communications link is wireless.

3. The apparatus of claim 2 wherein the wireless link is established using a wireless technology including Bluetooth, Home RF, IEEE802.1 a, or IEEE802.11b.

4. The apparatus of claim 1 wherein the wireless control set includes a graphical user interface.

5. The apparatus of claim 4 wherein the graphical user interface is a browser.

6. The apparatus of claim 1 wherein the wireless control set is battery powered.

7. The apparatus of claim 1 wherein the base set is powered by an AC power supply.

8. The apparatus of claim 2 wherein the network includes multiple instances of the base set and the control set communicates with a base set over a wireless link having a highest signal strength.

9. The apparatus of claim 1 wherein the first part of the UPnP stack includes addressing, discovery, description, eventing and control layers of the UPnP stack, and the base set further comprises:
a wrapper application layer;
a base set IP layer;
a control set PPP layer; and
a base set wireless stack.

10. The apparatus of claim 1 wherein the second part of the UPnP stack includes a presentation layer of the UPnP stack, and the control set further comprises:
an HTTP layer;
TCP/UDP layers;
a control set IP layer;
a control set PPP layer; and
a control set wireless stack.

11. A method for controlling devices connected to a wired network of UPnP devices comprising:
performing steps of discovery, description, eventing and control layers of a UPnP stack in a base set connected to the network by a wired communications link, the discovery, description, eventing and control layers forming a first part of a UPnP stack of a UPnP control point; and
performing steps of a presentation layer in a wireless control set connected to the base set via wireless communications link, the presentation layer forming a second part of the UPnP stack of the UPnP control point.
